(19) United States
(12) Patent Application Publication
(10) Pub. No.: US 2026/0280736 A1
(43) Pub. Date: Sep. 17, 2026

(54) Fast Transmission Parameter Adaptation Based on Effective Signal-To-Interference-Plus-Noise Ratio (eSINR)

(71) Applicant: QUALCOMM Incorporated, San Diego, CA (US)

(72) Inventors: Manikandan Chandrasekar, Bangalore (IN); Konchady Gautam Shenoy, Bangalore (IN); Bin Tian, San DIego, CA (US); Raj Kumar Krishna Kumar, Bangalore (IN)

(21) Appl. No.: 19/168,311

(22) PCT Filed: Mar. 20, 2024
(86) PCT No.: PCT/US24/20677

§ 371 Date: Sep. 23, 2025

(30) Foreign Application Priority Data
Mar. 23, 2023 (IN) 202321020430

(51) Int. Cl. H04B 17/309; H04L 1/00

(52) U.S. Cl. CPC H04B 17/346; H04L 1/0003

(57) ABSTRACT

This disclosure provides methods, components, devices and systems for managing characteristics of transmissions in wireless communication networks. Some aspects more specifically relate to the use of channel quality feedback to provide transmitting devices in such networks with guidance regarding suitable transmission parameters for their transmissions. According to some aspects, a wireless communication device can provide a second wireless communication device with channel feedback information indicating a modulation and coding scheme (MCS) and number of spatial streams for prospective transmissions of the second device. According to some aspects, the wireless communication device can select the MCS and N_{SS} based on an effective signal-to-interference-plus-noise (SINR) associated with receipt of a packet from the second device. In some examples, the wireless communication device can obtain the effective SINR (eSINR) using a lookup table, according to per-tone, per-spatial-stream SINRs associated with receipt of the packet.

### TECHNICAL FIELD

This disclosure relates generally to wireless communication, and more specifically, to fast transmission parameter adaptation.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In conjunction with transmitting bits of data to a receiving device in a wireless communication network, a wireless communication device in the network can convert the data bits into coded bits according to a forward error correction (FEC) code, such as a convolutional code or a low-density parity check (LDPC) code. The wireless communication device can generate modulation symbols based on the coded bits according to a modulation scheme (such as binary phase-shift keying (BPSK), quadrature phase-shift keying (QPSK), or quadrature amplitude modulation (QAM)) and generate a modulated carrier signal according to the modulation symbols. The wireless communication device can then generate a radio frequency (RF) signal based on the modulated carrier signal and transmit the RF signal to the receiving device. A modulation and coding scheme (MCS) that the wireless communication device applies for the transmission of the data bits can specify both the modulation scheme that is used and a coding rate of the FEC code.

According to a MAC-based rate adaptation scheme, a transmitting device may conduct transmission parameter adaptation based on, for example, the proportion of MAC protocol data units (MPDUs) that are successfully delivered to a receiving device, and thus may need to wait for receipt (or non-receipt) of acknowledgments from the receiving device before selecting and applying updated transmission parameters. A MAC-based rate adaptation scheme may involve a trial-and-error process of repeatedly applying incremental transmission parameter changes and assessing the results based on MPDU acknowledgment rates.

### SUMMARY

The systems, methods and devices of this disclosure each have several innovative aspects, no single one of which is solely responsible for the desirable attributes disclosed herein.

One innovative aspect of the subject matter described in this disclosure can be implemented in a wireless communication device. The wireless communication device includes at least one memory and at least one processor communicatively coupled with the at least one memory, the at least one processor operable to cause the wireless communication device to receive a packet from second wireless communication device and transmit a block acknowledgment frame to the second wireless communication device that includes channel feedback information indicating a set of transmission parameters, including a modulation and coding scheme (MCS), associated with an effective signal-to-interference-plus-noise ratio (SINR) associated with the receipt of the packet, where the effective SINR (eSINR) corresponds to an average mutual information rate (MIR) associated with the receipt of the packet according to an MIR-to-SINR mapping function.

Another innovative aspect of the subject matter described in this disclosure can be implemented in a method for wireless communication by a wireless communication device. The method includes receiving a packet from second wireless communication device and transmitting a block acknowledgment frame to the second wireless communication device that includes channel feedback information indicating a set of transmission parameters, including a MCS, associated with an eSINR associated with the receipt of the packet, where the eSINR corresponds to an average MIR associated with the receipt of the packet according to an MIR-to-SINR mapping function.

Another innovative aspect of the subject matter described in this disclosure can be implemented in a wireless communication device. The wireless communication device includes at least one memory and at least one processor communicatively coupled with the at least one memory, the at least one processor operable to cause the wireless communication device to transmit a packet to a second wireless communication device, receive a block acknowledgement frame from the second wireless communication device that includes channel feedback information indicating a set of transmission parameters including a MCS, and transmit a data frame to the second wireless communication device according to transmission parameters selected according to the indicated set of transmission parameters.

Another innovative aspect of the subject matter described in this disclosure can be implemented in a method for wireless communication by a wireless communication device. The method includes transmitting a packet to a second wireless communication device, receiving a block acknowledgement frame from the second wireless communication device that includes channel feedback information indicating a set of transmission parameters including a MCS, and transmitting a data frame to the second wireless communication device according to transmission parameters selected according to the indicated set of transmission parameters.

In some examples of the methods and wireless communication devices, the wireless communication device can be a wireless station (STA), and the second wireless communication device can be a wireless access point (AP).

In some other examples of the methods and wireless communication devices, the wireless communication device can be an AP, and the second wireless communication device can be a STA.

In some examples of the methods and wireless communication devices, the packet can include a probe frame or a quality of service (QoS) null frame.

In some examples of the methods and wireless communication devices, the set of transmission parameters can include a number of spatial streams (N_{SS}), and the channel feedback information can include an index value that indicates a combination of the MCS and the N_{SS}.

In some examples of the methods and wireless communication devices, the channel feedback information can indicate an SINR surplus associated with a difference between the eSINR and an SINR threshold that corresponds to a combination of the MCS and the N_{SS}.

In some other examples of the methods and wireless communication devices, the channel feedback information can indicate a first combination of the MCS and the N_{SS}, and can indicate an SINR shortfall associated with a difference between the eSINR and an SINR threshold that corresponds to a second combination of a MCS and a N_{SS} associated with a higher data rate capacity than the first combination.

In some examples of the methods and wireless communication devices, the set of transmission parameters can be selected according to the SINR and transmit power backoff information indicating a transmit power backoff associated with the MCS.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point and one or more wireless stations.

FIG. 3 shows an example physical layer (PHY) protocol data unit (PPDU) usable for communications between a wireless access point (AP) and one or more wireless stations (STAs).

FIG. 4 shows a hierarchical format of an example PPDU usable for communications between a wireless AP and one or more wireless STAs.

FIG. 5 shows a block diagram illustrating a first example operating environment.

FIG. 6 shows a block diagram illustrating a second example operating environment.

FIG. 7 shows a flowchart illustrating a first example process performable by a wireless communication device that supports fast transmission parameter adaptation based on an effective signal-to-interference-plus-noise ratio (eSINR).

FIG. 8 shows a flowchart illustrating a second example process performable by a wireless communication device that supports fast transmission parameter adaptation based on eSINR.

FIG. 9 shows a block diagram of a first example wireless communication device that supports fast transmission parameter adaptation based on eSINR.

FIG. 10 shows a block diagram of a second example wireless communication device that supports fast transmission parameter adaptation based on eSINR.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

Various aspects relate generally to wireless communication and more particularly to fast rate adaptation for transmissions in a wireless communication network. Some aspects more specifically relate to the use of channel quality feedback to provide a transmitting device in such a network with guidance regarding one or more transmission parameters to be used by the transmitting device in one or more upcoming transmissions to a receiving device. In some examples, the transmission parameters can include a modulation and coding scheme (MCS), a number of spatial streams, or both. In some examples, the transmitting device performs rate adaptation in conjunction with transmissions of packets to the receiving device according to a physical layer (PHY)-based rate adaptation scheme. According to the PHY-based rate adaptation scheme, the receiving device can determine one or more transmission parameters it recommends or requests the transmitting device to use in transmitting one or more subsequent packets to the receiving device based on one or more PHY-layer measurements or associated metrics determined by the receiving device associated with its previous or current receipt of one or more packets from the transmitting device. The receiving device can then transmit a message that includes channel feedback information explicitly or implicitly indicating the one or more recommended transmission parameters. In some examples, the channel feedback information can include an index value that indicates a combination of an MCS and a number of spatial streams. In some examples, the channel feedback information can be included in or with a block acknowledgement frame the receiving device transmits in response to receiving a single packet.

In various examples, the receiving device can more particularly select the one or more recommended transmission parameters based on an effective signal-to-interference-plus-noise ratio (SINR) associated with receipt of a single packet from the transmitting device. In some examples, the receiving device can measure per-tone, per-spatial-stream SINRs associated with receipt of the packet from the transmitting device, and can obtain the eSINR using a lookup table, according to the per-tone, per-spatial-stream SINR measurements. In some examples, the channel feedback information can indicate an SINR shortfall that represents or is associated with an extent to which the eSINR falls short of a threshold for applying a more aggressive set of one or more transmission parameters. In some other examples, the channel feedback information can indicate an SINR surplus that represents or is associated with an extent to which the eSINR exceeds a threshold for applying the one or more recommended transmission parameters. In some examples, in conjunction with obtaining the eSINR, the receiving device can take into account power backoffs that the transmitting device respectively applies for various MCSs. In some examples, the transmitting device can provide the receiving device with power backoff information that indicates such power backoffs.

Particular aspects of the subject matter described in this disclosure can be implemented to realize one or more of the following potential advantages. In some examples, the PHY-based rate adaptation scheme can enable the transmitting device to adapt its transmission parameters to channel conditions more quickly than it could according to a medium access control (MAC)-based scheme. In contrast, according to a PHY-based rate adaptation scheme as described herein, the receiving device can select transmission parameters and feed them back to the transmitting device, which is free to implement them upon receipt, without having to wait to accumulate and consider MAC-layer indicators such as MPDU acknowledgments. Further, according to a PHY-based rate adaptation scheme as described herein, the receiving device can determine and feed back recommended transmission parameters based on receipt of a single packet. As a result, the transmitting device can adopt approximately throughput-optimizing transmission parameters at an earlier point in time, making its transmission parameter adaptation both more rapid and less wasteful of available throughput capacity. The ability to more quickly and more precisely adapt its transmission parameters to channel conditions can enable the transmitting device to achieve improved average throughput rates when channel conditions are dynamic.

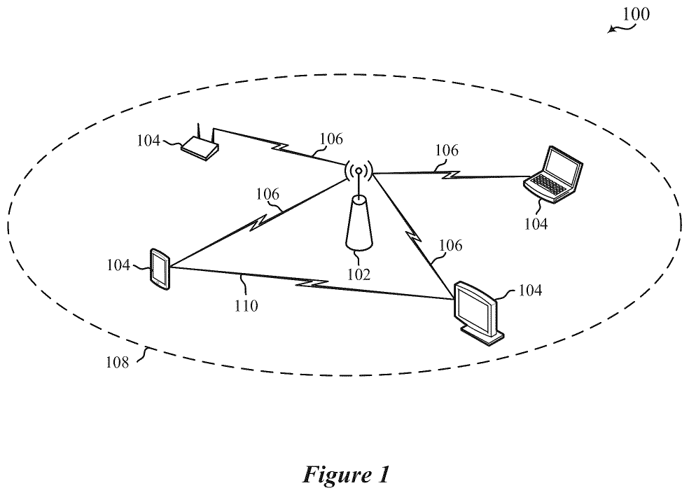

FIG. 1 shows a block diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The WLAN 100 may include numerous wireless communication devices such as a wireless AP 102 and multiple wireless STAs 104. While only one AP 102 is shown in FIG. 1, the WLAN network 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE, 5G NR, etc.) can be further improved by a small cell which is supported by an AP serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IoT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHZ, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some examples of the APs 102 and STAs 104 described herein also may communicate in other frequency bands, such as the 5.9 GHZ and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

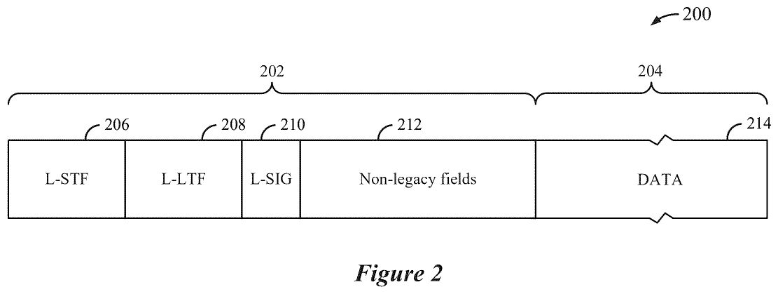

FIG. 2 shows an example protocol data unit (PDU) 200 usable for wireless communication between a wireless AP 102 and one or more wireless STAs 104. For example, the PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device to perform coarse timing and frequency tracking and automatic gain control (AGC). The L-LTF 208 generally enables a receiving device to perform fine timing and frequency tracking and also to perform an initial estimate of the wireless channel. The L-SIG 210 generally enables a receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

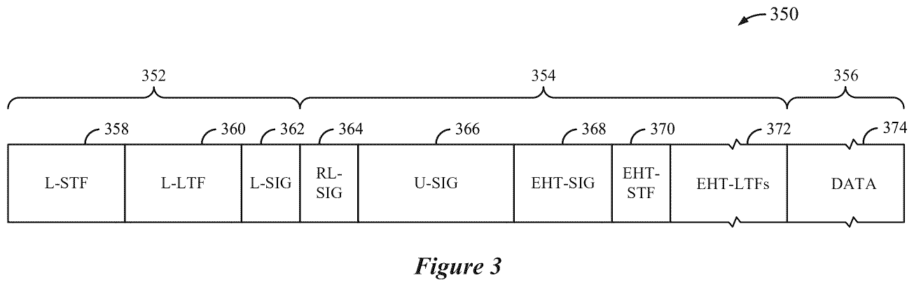

FIG. 3 shows another example PPDU 350 usable for wireless communication between a wireless AP and one or more wireless STAs. The PPDU 350 may be used for SU, OFDMA or MU-MIMO transmissions. The PPDU 350 may be formatted as an Extremely High Throughput (EHT) WLAN PPDU in accordance with the IEEE 802.11be amendment to the IEEE 802.11 family of wireless communication protocol standards, or may be formatted as a PPDU conforming to any later (post-EHT) version of a new wireless communication protocol conforming to a future IEEE 802.11 wireless communication protocol standard, such as the 802.11 amendment associated with Wi-Fi 8), or another wireless communication standard. The PPDU 350 includes a PHY preamble including a legacy portion 352 and a non-legacy portion 354. The PPDU 350 may further include a PHY payload 356 after the preamble, for example, in the form of a PSDU including a data field 374.

The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and U-SIG 366 may indicate to EHT- or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP to identify and inform one or multiple STAs 104 that the AP has scheduled UL or DL resources for them. EHT-SIG 368 may be decoded by each compatible STA 104 served by the AP 102. EHT-SIG 368 may generally be used by a receiving device to interpret bits in the data field 374. For example, EHT-SIG 368 may include RU allocation information, spatial stream configuration information, and per-user (for example, STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some wireless communications environments, Extremely High Throughput (EHT) systems or other systems compliant with future generations of the IEEE 802.11 family of wireless communication protocol standards may provide additional capabilities over other previous systems (for example, High Efficiency (HE) systems or other legacy systems). EHT and newer wireless communication protocols may support flexible operating bandwidth enhancements at APs and STAs, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz and 320 MHz. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device operates in a contiguous 320 MHz bandwidth mode or a 160+160 MHz bandwidth mode. Signals for transmission may be generated by two different transmit chains of the device each having a bandwidth of 160 MHz (and each coupled to a different power amplifier). In some other examples, signals for transmission may be generated by four or more different transmit chains of the device, each having a bandwidth of 80 MHz.

In some other examples, the wireless communication device may operate in a contiguous 240 MHz bandwidth mode, or a noncontiguous 160+80 MHz bandwidth mode. In some examples, the signals for transmission may be generated by three different transmit chains of the device, each having a bandwidth of 80 MHz. In some other examples, the 240 MHz/160+80 MHz bandwidth modes may also be formed by puncturing 320/160+160 MHz bandwidth modes with one or more 80 MHz subchannels. For example, signals for transmission may be generated by two different transmit chains of the device each having a bandwidth of 160 MHz with one of the transmit chains outputting a signal having an 80 MHz subchannel punctured therein.

The operating bandwidth also may accommodate concurrent operation on other unlicensed frequency bands (such as the 6 GHz band) and a portion of spectrum that includes frequency bands traditionally used by Wi-Fi technology. In noncontiguous examples, the operating bandwidth may span one or more disparate sub-channel sets. For example, the 320 MHz bandwidth may be contiguous and located in the same 6 GHz band or noncontiguous and located in different bands (such as partly in the 5 GHz band and partly in the 6 GHz band).

In some examples, operability enhancements associated with EHT and newer generations of the IEEE 802.11 family of wireless communication protocols, and in particular operation at an increased bandwidth, may include refinements to carrier sensing and signal reporting mechanisms. Such techniques may include modifications to existing rules, structure, or signaling implemented for legacy systems.

Transmitting and receiving devices may support the use of various modulation and coding schemes (MCSs) to transmit and receive data so as to optimally take advantage of wireless channel conditions, for example, to increase throughput, reduce latency, or enforce various quality of service (QoS) parameters. For example, existing technology supports the use of up to 1024-QAM, where a modulated symbol carries 10 bits. To further improve peak data rate, 4096-QAM (also referred to as “4k QAM”), which enables a modulated symbol to carry 12 bits, also may be implemented. 4096-QAM may enable a 20% increase in data rate capacity compared to 1024-QAM given the same coding rate, thereby allowing users to obtain higher transmission efficiency.

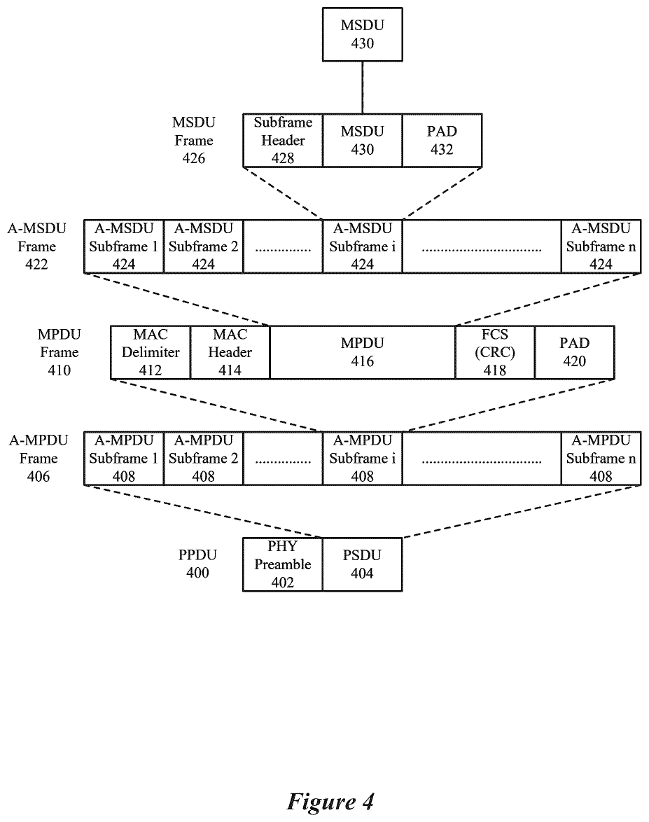

FIG. 4 shows a hierarchical format of an example PPDU usable for communications between a wireless AP 102 and one or more wireless STAs 104. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 406 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (for example, the FCS field may include a cyclic redundancy check (CRC)) and padding bits 420. The MPDU 416 may carry one or more MAC service data units (MSDUs) 416. For example, the MPDU 416 may carry an aggregated MSDU (A-MSDU) 422 including multiple A-MSDU subframes 424. Each A-MSDU subframe 424 contains a corresponding MSDU 430 preceded by a subframe header 428 and in some cases followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body 416. The MAC header 414 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 414 also includes one or more fields indicating addresses for the data encapsulated within the frame body 416. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

APs and STAs that include multiple antennas may support various diversity schemes. For example, spatial diversity may be used by one or both of a transmitting device or a receiving device to increase the robustness of a transmission. For example, to implement a transmit diversity scheme, a transmitting device may transmit the same data redundantly over two or more antennas.

APs and STAs that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number NsTs of space-time streams, which are then mapped to N_{Tx} transmit chains.

APs and STAs that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are then separately encoded and transmitted in parallel via the multiple N_{Tx} transmit antennas. APs and STAs that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU multiple-input multiple-output (MIMO) (MU-MIMO) transmissions (also referred to as spatial division multiple access (SDMA)). In the MU-MIMO context, beamforming may additionally or alternatively involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (for example, in the form of a null data packet (NDP)) to the beamformee. An NDP is a PPDU without any data field. The beamformee may then perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may then generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (for example, identify, detect, ascertain, calculate, or compute) how to transmit a signal on each of its antennas to perform beamforming. For example, the steering matrix may be indicative of a phase shift, power level, etc. to use to transmit a respective signal on each of the beamformer's antennas.

A transmitting device may support the use of diversity schemes. When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP's spatial multiplexing capability, an AP may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For examples, the CSI feedback overhead may be reduced using an implicit channel sounding procedure such as an implicit beamforming report (BFR) technique (such as where STAs transmit NDP sounding packets in the UL while the AP measures the channel) because no BFRs are sent. Once the AP receives the NDPs, it may implicitly assess the channels for each of the STAs and use the channel assessments to configure steering matrices. In order to mitigate hardware mismatches that could break the channel reciprocity on the UL and DL (such as the baseband-to-RF and RF-to-baseband chains not being reciprocal), the AP may implement a calibration method to compensate for the mismatch between the UL and the DL channels. For example, the AP may select a reference antenna, transmit a pilot signal from each of its antennas, and estimate baseband-to-RF gain for each of the non-reference antennas relative to the reference antenna.

In some examples, multiple APs may transmit to one or more STAs at a time utilizing a distributed MU-MIMO scheme. Examples of such distributed MU-MIMO transmissions include coordinated beamforming (CBF) and joint transmission (JT). With CBF, signals (such as data streams) for a given STA may be transmitted by only a single AP. However, the coverage areas of neighboring APs may overlap, and signals transmitted by a given AP may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP may beamform signals to in-BSS STAs while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA may be transmitted by multiple coordinated APs. For the multiple APs to concurrently transmit data to a STA, the multiple APs may all need a copy of the data to be transmitted to the STA. Accordingly, the APs may need to exchange the data among each other for transmission to a STA. With JT, the combination of antennas of the multiple APs transmitting to one or more STAs may be considered as one large antenna array (which may be represented as a virtual antenna array) used for beamforming and transmitting signals. In combination with MU-MIMO techniques, the multiple antennas of the multiple APs may be able to transmit data via multiple spatial streams. Accordingly, each STA may receive data via one or more of the multiple spatial streams.

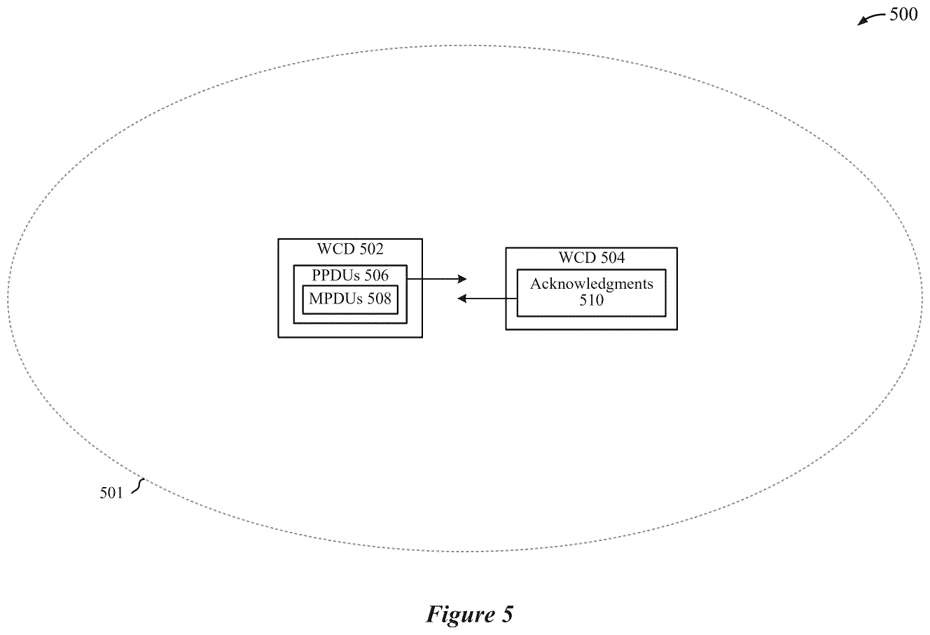

FIG. 5 shows a block diagram illustrating a first example operating environment 500. In the operating environment 500, a wireless communication device 502 and a wireless communication device 504 operate in a wireless communication network 501. The wireless communication network 501 can be a WLAN in which devices such as the wireless communication device 502 and the wireless communication device 504 wirelessly communicate according to protocols and procedures defined in the IEEE 802.11 family of wireless communication standards. In some examples, the wireless communication device 502 can operate as or within a wireless access point (AP) such as the AP 102 described with reference to FIG. 1, and the wireless communication device 504 can operate as or within a wireless station (STA) such as one of the STAs 104 described with reference to FIG. 1. In some other examples, the wireless communication device 502 can operate as or within a STA such as one of the STAs 104 described with reference to FIG. 1, and the wireless communication device 504 can operate as or within an AP such as the AP 102 described with reference to FIG. 1.

In the operating environment 500, the wireless communication device 502 can transmit PPDUs 506 to the wireless communication device 504. The PPDUs 506 can encapsulate MPDUs 508, which in turn can encapsulate MSDUs (not shown). In some examples, any given one of the PPDUs 506 may encapsulate multiple MPDUs 508. For instance, a given PPDU 506 may encapsulate an A-MPDU that includes multiple MPDUs 508.

In order inform the wireless communication device 502 that it has successfully received MPDUs 508 encapsulated in the PPDUs 506, the wireless communication device 504 can transmit acknowledgments 510 to the wireless communication device 502. In some examples, the acknowledgments 510 can include block acknowledgments (BlockAcks), any given one of which can acknowledge multiple MPDUs 508. In some examples, the acknowledgments 510 can additionally or alternatively include per-MPDU acknowledgments, any given one of which can acknowledge a single MPDU 508.

The rate at which the wireless communication device 502 provides the wireless communication device 504 with useful bits of higher-layer information (hereinafter, the “goodput rate”) in operating environment 500 can depend on the PHY data rate according to which the wireless communication device 502 transmits the PPDUs 506 and the success rate that the wireless communication device 504 achieves in reconstructing the PPDUs 506 from transmissions received from the wireless communication device 502 and obtaining the MPDUs 508 encapsulated therein.

The PHY data rate can depend on a set of transmission parameters according to which the wireless communication device 502 transmits the PPDUs 506. This set of transmission parameters can include a modulation scheme and a coding rate-collectively, a modulation and coding scheme (MCS)—that the wireless communication device 502 applies in conjunction with transmitting the PPDUs 506 and a number of spatial streams (N_{SS}) via which the wireless communication device 502 transmits the PPDUs 506. The success rate that the wireless communication device 504 achieves in reconstructing the PPDUs 506 from transmissions received from the wireless communication device 502 and obtaining the MPDUs 508 encapsulated therein can depend on the conditions of the wireless channel and the resilience of the wireless communication device 502's transmissions to channel impairments.

An inverse relationship can exist between the aggressiveness of the set of transmission parameters according to which the wireless communication device 502 transmits the PPDUs 506 and the resilience of those transmissions, and thus to the success rate that the wireless communication device 504 achieves in reconstructing the PPDUs 506 and obtaining the MPDUs 508. More aggressive sets of transmission parameters—that is, sets of transmission parameters corresponding to higher PHY data rates—can be less resilient to channel impairments than more conservative sets of transmission parameters corresponding to lower PHY data rates.

For given channel conditions, a most aggressive set of transmission parameters that is sufficiently resilient to tolerate those channel conditions can generally be expected to yield an optimal goodput rate. Applying an overly aggressive set of transmission parameters that is not sufficiently resilient to the channel conditions may impair the wireless communication device 504's ability to reconstruct the PPDUs 506 from transmissions received from the wireless communication device 502 and obtain the MPDUs 508 encapsulated therein, and may yield a sub-optimal goodput rate. Applying an overly conservative set of transmission parameters that corresponds to a lower PHY data rate than other sets of transmission parameters that are sufficiently resilient to the channel conditions may result in the PPDUs 506 being transmitted to the wireless communication device 504 unnecessarily slowly, and may likewise yield a sub-optimal goodput rate.

In order to attempt to optimize the goodput rate over time as it transmits the PPDUs 506 to the wireless communication device 504, the wireless communication device 502 can adapt the transmission parameters according to which it transmits the PPDUs 506 based on the channel conditions. In various implementations, the wireless communication device 502 can adapt its transmission parameters according to a two-dimensional (2D) rate adaptation scheme. According to a 2D rate adaptation scheme, the wireless communication device 502 assess whether its transmission parameters are sufficiently resilient to channel conditions based on the success rate associated with delivery of the MPDUs 508 to the wireless communication device 504, as indicated by the receipt (or non-receipt) of the acknowledgments 510 for the MPDUs 508. If too high a proportion of the MPDUs 508 are unacknowledged, the wireless communication device 502 can conclude that its transmission parameters are too aggressive for channel conditions, and can switch to a less aggressive set of transmission parameters. If the proportion of unacknowledged MPDUs 508 is sufficiently low, the wireless communication device 502 can conclude that its transmission parameters are not too aggressive, and can maintain those transmission parameters or can switch to a more aggressive set of transmission parameters.

There may be significant latency associated with transmission parameter adaptation according to such a 2D rate adaptation scheme, due to the need for the wireless communication device 502 to wait to see whether it receives the acknowledgments 510 for the MPDUs 508. The wireless communication device 502 cannot make an accurate determination of whether a given MPDU 508 has been acknowledged until it has given the wireless communication device 504 time to extract the MPDU 508 from its encapsulating PPDU 506, verify the integrity of the MPDU 508, generate an acknowledgment 510 for the MPDU 508, encapsulate the acknowledgment 510 in a PPDU (not shown), and transmit the PPDU to the wireless communication device 502. The wireless communication device 502 also needs to allow itself time to extract the acknowledgment 510 of the MPDU 508 from the received PPDU and process the acknowledgment 510. The amount of time that the wireless communication device 502 needs to wait to accommodate these various operations can be significant.

There may be other inefficiencies associated with transmission parameter adaptation according to such a 2D rate adaptation scheme as well. For example, when the rate of acknowledgment of the MPDUs 508 is high, it may be difficult for the wireless communication device 502 to tell whether this means that its transmission parameters are appropriate for channel conditions or too conservative, and if the latter, the extent to which they are too conservative. The wireless communication device 502 may be able to make this determination via a trial-and-error process, but such a process may involve an inefficient, potentially lengthy series of incremental increases in transmission parameter aggressiveness before most a most suitable set of transmission parameters is identified. The inefficiency of such a process may especially pronounced when channel conditions vary rapidly.

Disclosed herein are techniques for fast transmission parameter adaptation based on eSINR. According to such techniques, the wireless communication device 502 can implement a PHY-based rate adaptation scheme to achieve improved goodput rates relative to those achievable via a 2D rate adaptation scheme. According to the PHY-based rate adaptation scheme, the wireless communication device 504 can assess the channel conditions by determining an eSINR associated with receipt of a packet from the wireless communication device 502, identify a set of transmission parameters expected to be appropriate for the channel conditions based on the eSINR, and inform the wireless communication device 502 of the identified set of transmission parameters by sending channel feedback information to the wireless communication device 502.

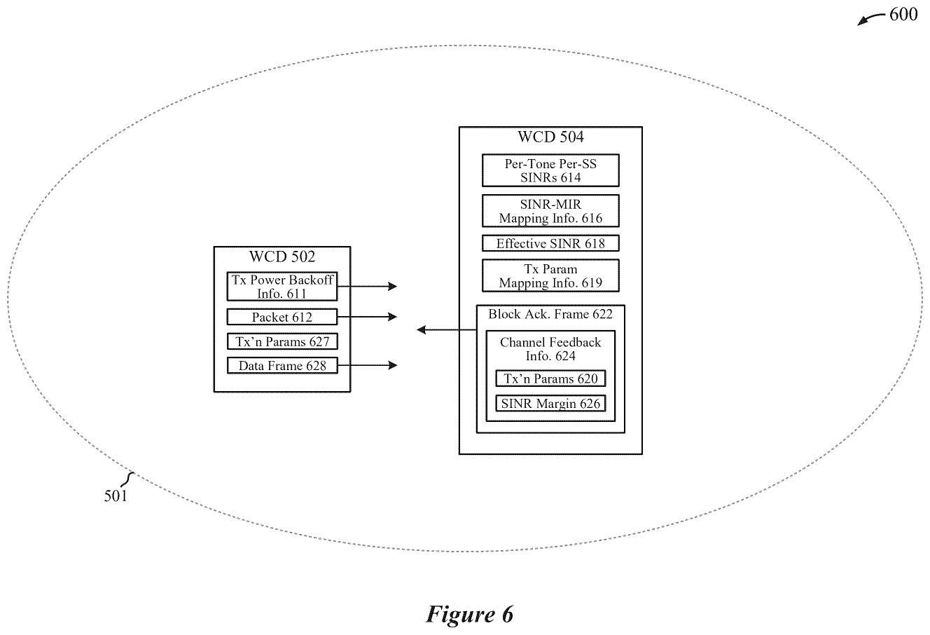

FIG. 6 shows a block diagram illustrating a second example operating environment 600. The wireless communication devices 502 and 504 can implement techniques for fast transmission parameter adaptation based on eSINR in the operating environment 600 in order to adapt to changes in channel conditions more quickly and more precisely, and realize improved goodput rates.

In the operating environment 600, the wireless communication devices 502 and 504 can implement a PHY-based rate adaptation scheme. According to the PHY-based rate adaptation scheme, the wireless communication device 504 can select transmission parameters 620 based on PHY-layer metrics associated with its receipt from the wireless communication device 502 of a packet 612, and can provide the wireless communication device 502 with channel feedback information 624 indicating the transmission parameters 620. In various examples, the packet 612 can be a null data packet (NDP). In some examples, the packet 612 can include a probe frame, such as a probe response frame. In some other examples, the packet 612 can include a quality of service (QoS) null frame. According to aspects of the disclosure, the transmission parameters 620 can include a modulation and coding scheme (MCS). In some examples, the transmission parameters 620 can further include a number of spatial streams (N_{SS}). In various examples, the channel feedback information 624 can include an index value that indicates a combination of the MCS and the N_{SS}. In some examples, the wireless communication device 504 can provide the wireless communication device 502 with the channel feedback information 624 by transmitting a block acknowledgment frame 622 that includes the channel feedback information 624 to the wireless communication device 502.

According to aspects of the disclosure, the wireless communication device 504 can select the transmission parameters 620 based on an eSINR 618 associated with its receipt of the packet 612. In various examples, the wireless communication device 504 can select the transmission parameters 620 according to transmission parameter mapping information 619 that indicates correspondences between SINR value ranges and sets of transmission parameters. In some examples, the transmission parameter mapping information 619 can reflect SINR value range to transmission parameter mappings determined via offline training.

According to aspects of the disclosure, the transmission parameter mapping information 619 can indicate mappings of SINR value ranges to MCS-N_{SS} combinations. In some examples, the transmission parameter mapping information 619 can define a set of multiple SINR thresholds, which can include a respective SINR threshold for each of multiple MCS-N_{SS} combinations. In various examples, each of the multiple SINR thresholds can be a value to which the eSINR 618 can be compared in order to determine whether the quality of the wireless channel is sufficient to support transmission according to a respective one of the multiple MCS-N_{SS} combinations. In some examples, the eSINR threshold values can increase as their respective corresponding MCS-N_{SS} combinations increase in aggressiveness. In various examples, for each of the multiple MCS-N_{SS} combinations, the corresponding SINR value range can span from the SINR threshold for that MCS-N_{SS} combination to the SINR threshold of an MCS-N_{SS} combination that is one step higher in aggressiveness. For instance, an SINR value range for a second-most aggressive MCS-N_{SS} combination can span from a SINR threshold for that MCS-N_{SS} combination to an SINR threshold for a most aggressive MCS-N_{SS} combination, an SINR value range for a third-most aggressive MCS-N_{SS} combination can span from a SINR threshold for that MCS-N_{SS} combination to the SINR threshold for the second-most aggressive MCS-N_{SS} combination, and so forth.

According to aspects of the disclosure, the wireless communication device 504 can estimate per-tone, per-spatial-stream SINRs 614 associated with receipt of the packet 612 from the wireless communication device 502, and can use the per-tone, per-spatial-stream SINRs 614 to obtain the eSINR 618 associated with receipt of the packet 612. In various examples, the wireless communication device 504 can estimate the per-tone, per-spatial-stream SINRs 614 via minimum mean square error (MMSE) SINR estimation based on one or more training fields of the packet 612. In some examples, the one or more training fields can be long training fields (LTFs), such as high-efficiency LTFs (HE-LTFs).

According to aspects of the disclosure, the wireless communication device 504 can obtain the eSINR 618 using the per-tone, per-spatial-stream SINRs 614 based on SINR-mutual information rate (MIR) mapping information 616. In various examples, the SINR-MIR mapping information 616 can indicate correspondences between SINRs and MIRs. In some examples, the SINR-MIR mapping information 616 can indicate mappings of SINRs to MIRs according to an SINR-to-MIR mapping function Φ, and mappings of MIRs to SINRs according to an MIR-to-SINR mapping function Φ⁻¹ that is the inverse of the SINR-to-MIR mapping function. According to aspects of the disclosure, the SINR-to-MIR mapping function Φ can map SINRs to symbol-level mutual information rates, and the MIR-to-SINR mapping function Φ⁻¹ can map symbol-level mutual information rates to SINRs. In various examples, the wireless communication device 504 can apply SINR-to-MIR and MIR-to-SINR mappings indicated by the SINR-MIR mapping information 616 to obtain the eSINR 618 based on the per-tone, per-spatial-stream SINRs 614 according to Equation (1) as follows:

$$eSINR = α \cdot {Φ}^{- 1} ( \frac{1}{N} {\sum }_{n = 1}^{N} Φ ( \frac{{SINR}_{n}}{β} ) ) \qquad ( 1 )$$

where α and β are hedge factors, the values of which can be calibrated to compensate for residual errors.

According to aspects of the disclosure, the SINR-MIR mapping information 616 can include one or more lookup tables (LUTs) that indicate SINR-to-MIR mappings (such as according to an SINR-to-MIR mapping function Φ), MIR-to-SINR mappings (such as according to an MIR-to-SINR mapping function Φ⁻¹), or both. In some examples, the one or more LUTs can indicate SINR-to-MIR mappings, MIR-to-SINR mappings, or both based on received bit mutual information rates (RBIRs) that represent average symbol level mutual information rates conditioned on modulation scheme.

In various examples, the wireless communication device 504 can convert the per-tone per-spatial-stream SINRs 614 to MIRs according to SINR-to-MIR mappings indicated by the SINR-MIR mapping information 616, determine an average of the MIRs, and obtain the eSINR 618 based on the average MIR according to an MIR-to-SINR mapping indicated by the SINR-MIR mapping information 616.

According to aspects of the disclosure, the wireless communication device 504 can include an SINR margin 626 in the channel feedback information 624. In some examples, the SINR margin 626 can indicate an SINR surplus representing an amount by which the eSINR 618 exceeds an SINR threshold associated with the transmission parameters 620. In other examples, the SINR margin 626 can indicate an SINR shortfall representing an amount by which the eSINR 618 falls short of an SINR threshold associated with a set of transmission parameters that is one step up (in terms of aggressiveness and thus data rate capacity) than the transmission parameters 620. In various examples, the SINR margin 626 can be a quantized value.

In various examples, the transmit power that the wireless communication device 502 uses for a given transmission can depend on the MCS that the wireless communication device 502 applies for that transmission. In some examples, the wireless communication device 502 can apply transmit power backoffs in conjunction with transmissions according to one or more MCSs, and the applied transmit power backoffs may vary from MCS to MCS. According to aspects of the disclosure, in order to inform the wireless communication device 504 of its transmit power backoffs for one or more MCSs, the wireless communication device 502 can provide the wireless communication device 504 with transmit power backoff information 611. In some examples, the wireless communication device 502 can provide the wireless communication device 504 with the transmit power backoff information 611 during or closely following initial association.

According to aspects of the disclosure, the wireless communication device 502 can select transmission parameters 627 for transmission of a data frame 628 according to the transmission parameters 620 indicated by the channel feedback information 624, and can transmit the data frame 628 to the wireless communication device 504 according to the selected transmission parameters 627. In some examples, the wireless communication device 502 can simply adopt the transmission parameters 620 indicated by the channel feedback information 624 as the transmission parameters 627 for transmission of the data frame 628. In various examples, the wireless communication device 502 can selectively apply or modify the indicated transmission parameters 620 based on additional considerations. For instance, if the channel feedback information 624 includes an SINR margin 626 indicating that the eSINR 618 is very close to an SINR threshold for a more aggressive set of transmission parameters, and the wireless communication device 502 has detected an upward trend in channel quality, the wireless communication device 502 may adopt the more aggressive set of transmission parameters as the transmission parameters 627 for transmission of the data frame 628. In another example, if the wireless communication device 502 has only a small amount of data to transmit in the data frame 628, it may adopt a less aggressive set of transmission parameters as the transmission parameters 627 rather than using the transmission parameters 620.

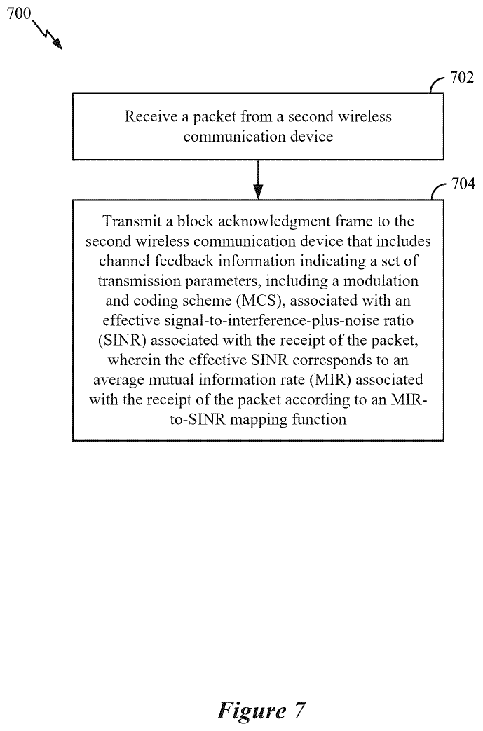

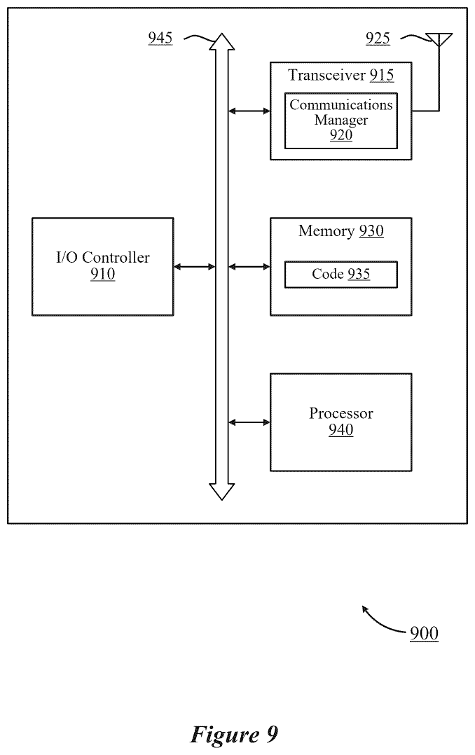

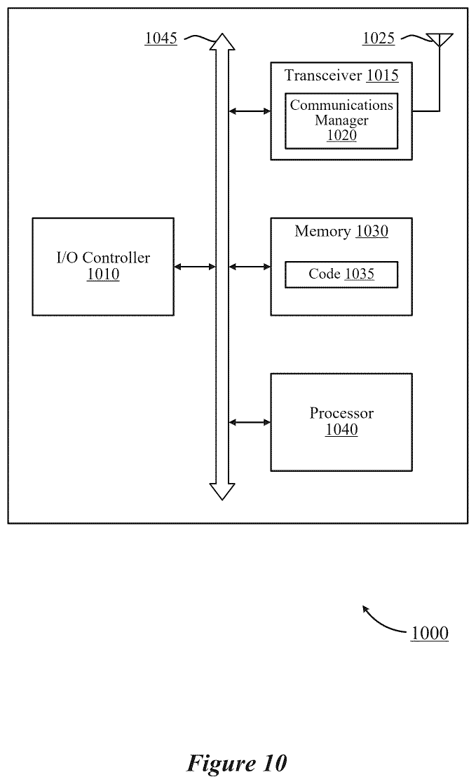

FIG. 7 shows a flowchart illustrating an example process 700 performable by a wireless communication device that supports fast transmission parameter adaptation based on eSINR according to some aspects of the present disclosure. The operations of the process 700 may be implemented by a wireless STA or AP, or its components, as described herein. In some examples, the process 700 may be performed by a wireless communication device, such as the wireless communication device 504 described with reference to FIGS. 5 and 6 or the wireless communication device 900 described with reference to FIG. 9, operating as or within a wireless STA. In some examples, the process 700 may be performed by a wireless communication device, such as the wireless communication device 504 described with reference to FIGS. 5 and 6 or the wireless communication device 1000 described with reference to FIG. 10, operating as or within a wireless AP. In some examples, the process 700 may be performed by a wireless AP such as the wireless AP 102 described with reference to FIG. 1. In some examples, the process 700 may be performed by a wireless STA such as one of the wireless STAs 104 described with reference to FIG. 1.

In some examples, in block 702, the wireless communication device can receive a packet from a second wireless communication device. For example, in the operating environment 600 of FIG. 6, the wireless communication device 504 can receive the packet 612 from the wireless communication device 502. In some examples, the wireless communication device can be a STA, and the second wireless communication device can be an AP. In some other examples, the wireless communication device can be an AP, and the second wireless communication device can be a STA. In some examples, the packet can include a probe frame. In some other examples, the packet can include a quality of service (QoS) null frame.

In some examples, in block 704, the wireless communication device can transmit a block acknowledgment frame to the second wireless communication device that includes channel feedback information indicating a set of transmission parameters, including a modulation and coding scheme (MCS), associated with an effective signal-to-interference-plus-noise ratio (SINR) associated with the receipt of the packet, where the effective SINR (eSINR) corresponds to an average mutual information rate (MIR) associated with the receipt of the packet according to an MIR-to-SINR mapping function. For example, in the operating environment 600 of FIG. 6, the wireless communication device 504 can transmit the block acknowledgment frame 622 to the wireless communication device 502, the block acknowledgment frame 622 can include the channel feedback information 624, the channel feedback information 624 can indicate the transmission parameters 620, the transmission parameters 620 can be associated with the eSINR 618 associated with the receipt of the packet 612 and can include an MCS, and the eSINR 618 can correspond to an average MIR associated with the receipt of the packet 612 according to an MIR-to-SINR mapping function included in the SINR/MIR mapping information 616.

In some examples, the set of transmission parameters can further include a number of spatial streams (N_{SS}). In some such examples, the channel feedback information can include an index value that indicates a combination of the MCS and the N_{SS}. In some examples, the channel feedback information can indicate an SINR surplus associated with a difference between the eSINR and an SINR threshold that corresponds to a combination of the MCS and the N_{SS}. For example, in the operating environment 600 of FIG. 6, the channel feedback information 624 can include an SINR margin 626 that indicates an SINR surplus associated with a difference between the eSINR 618 and an SINR threshold that corresponds to a combination of the MCS and the N_{SS}. In some other examples, the channel feedback information can indicate a first combination of the MCS and the N_{SS}, and can indicate an SINR shortfall associated with a difference between the eSINR and an SINR threshold that corresponds to a second combination of a MCS and a N_{SS} associated with a higher data rate capacity than the first combination. For example, in the operating environment 600 of FIG. 6, the channel feedback information 624 can indicate a first combination of the MCS and the N_{SS} and can include an SINR margin 626 that indicates an SINR shortfall associated with a difference between the eSINR 618 and an SINR threshold that corresponds to a second combination of a MCS and a N_{SS} associated with a higher data rate capacity than the first combination.

In some examples, the wireless communication device can estimate a plurality of SINRs for a plurality of tones for a plurality of spatial streams, on a per-tone per-spatial-stream basis, associated with receipt of the packet, and obtain the eSINR using a lookup table (LUT) according to the estimated plurality of SINRs. For example, in the operating environment 600 of FIG. 6, the wireless communication device 504 can estimate a plurality of SINRs for a plurality of tones for a plurality of spatial streams, on a per-tone per-spatial-stream basis, associated with receipt of the packet 612 from the wireless communication device 502, and can obtain the eSINR 618 using a LUT included in the SINR/MIR mapping information 616 according to the estimated plurality of SINRs.

In some examples, the wireless communication device can select the set of transmission parameters according to transmission parameter mapping information that indicates a mapping of the eSINR to the set of transmission parameters. For example, in the operating environment 600 of FIG. 6, the wireless communication device 504 can select the transmission parameters 620 according to the transmission parameter mapping information 619, which can indicate a mapping of the eSINR 618 to the transmission parameters 620.

In some examples, the wireless communication device can select the set of transmission parameters according to the eSINR and transmit power backoff information obtained from the second wireless communication device, and the transmit power backoff information can indicate a transmit power backoff associated with the MCS. For example, in the operating environment 600 of FIG. 6, the wireless communication device 504 can select the transmission parameters 620 according to the eSINR 618 and the transmit power backoff information 611 obtained from the wireless communication device 502, and the transmit power backoff information 611 can indicate a transmit power backoff associated with the MCS included in the transmission parameters 620. In some examples, the transmit power backoff information can indicate respective associated transmit power backoffs for each of a plurality of MCSs including the MCS. In some examples, the wireless communication device can obtain the transmit power backoff information from the second wireless communication device during an association of the wireless communication device with the second wireless communication device.

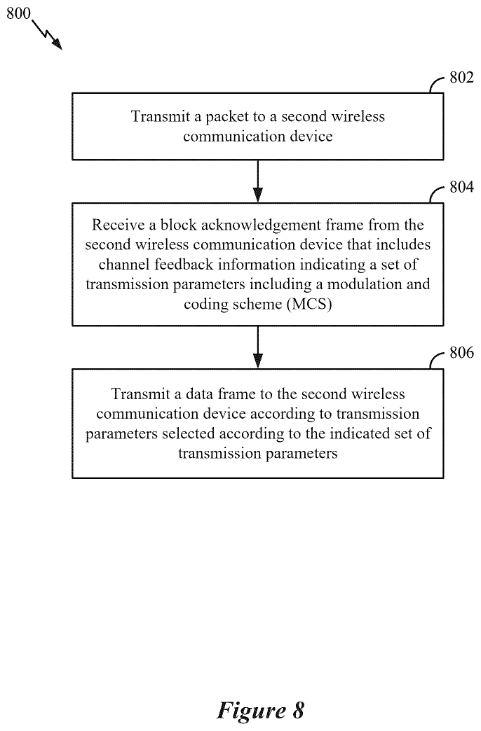

FIG. 8 shows a flowchart illustrating an example process 800 performable at a wireless STA that supports fast transmission parameter adaptation based on eSINR according to some aspects of the present disclosure. The operations of the process 800 may be implemented by a wireless STA or AP, or its components, as described herein. In some examples, the process 800 may be performed by a wireless communication device, such as the wireless communication device 502 described with reference to FIGS. 5 and 6 or the wireless communication device 900 described with reference to FIG. 9, operating as or within a wireless STA. In some examples, the process 800 may be performed by a wireless communication device, such as the wireless communication device 502 described with reference to FIGS. 5 and 6 or the wireless communication device 1000 described with reference to FIG. 10, operating as or within a wireless AP. In some examples, the process 800 may be performed by a wireless AP such as the wireless AP 102 described with reference to FIG. 1. In some examples, the process 700 may be performed by a wireless STA such as one of the wireless STAs 104 described with reference to FIG. 1.

In some examples, in block 802, the wireless communication device can transmit a packet to a second wireless communication device. For example, in the operating environment 600 of FIG. 6, the wireless communication device 502 can transmit the packet 612 to the wireless communication device 504. In some examples, the wireless communication device can be a STA, and the second wireless communication device can be an AP. In some other examples, the wireless communication device can be an AP, and the second wireless communication device can be a STA. In some examples, the packet can include a probe frame. In some other examples, the packet can include a quality of service (QoS) null frame.

In some examples, in block 804, the wireless communication device can receive a block acknowledgement frame from the second wireless communication device that includes channel feedback information indicating a set of transmission parameters including a modulation and coding scheme (MCS). For example, in the operating environment 600 of FIG. 6, the wireless communication device 502 can receive the block acknowledgment frame 622 from the wireless communication device 504, the block acknowledgment frame 622 can include the channel feedback information 624, the channel feedback information 624 can indicate the transmission parameters 620, and the transmission parameters 620 can include an MCS.

In some examples, the set of transmission parameters can further include a number of spatial streams (N_{SS}). In some such examples, the channel feedback information can include an index value that indicates a combination of the MCS and the N_{SS}. In some examples, the channel feedback information can indicate an SINR surplus associated with a difference between an eSINR associated with a receipt of the packet by the second wireless communication device and an SINR threshold that corresponds to a combination of the MCS and the N_{SS}. For example, in the operating environment 600 of FIG. 6, the channel feedback information 624 can include an SINR margin 626 that indicates an SINR surplus associated with a difference between the eSINR 618 associated with the receipt of the packet 612 by the wireless communication device 504 and an SINR threshold that corresponds to a combination of the MCS and the N_{SS}. In some other examples, the channel feedback information can indicate a first combination of the MCS and the N_{SS}, and can indicate an SINR shortfall associated with a difference between an eSINR associated with a receipt of the packet by the second wireless communication device and an SINR threshold that corresponds to a second combination of a MCS and a N_{SS} associated with a higher data rate capacity than the first combination. For example, in the operating environment 600 of FIG. 6, the channel feedback information 624 can indicate a first combination of the MCS and the N_{SS} and can include an SINR margin 626 that indicates an SINR shortfall associated with a difference between the eSINR 618 and an SINR threshold that corresponds to a second combination of a MCS and a N_{SS} associated with a higher data rate capacity than the first combination.

In some examples, the wireless communication device can provide transmit power backoff information to the second wireless communication device, and the transmit power backoff information can indicate a transmit power backoff to be applied by the wireless communication device for the MCS. For example, in the operating environment 600 of FIG. 6, the wireless communication device 502 can provide the transmit power backoff information 611 to the wireless communication device 504, and the transmit power backoff information 611 can indicate a transmit power backoff associated with the MCS included in the transmission parameters 620. In some examples, the transmit power backoff information can indicate respective transmit power backoffs to be applied by the wireless communication device for each of a plurality of MCSs including the MCS. In some examples, the wireless communication device can provide the transmit power backoff information to the second wireless communication device during an association of the wireless communication device with the second wireless communication device.

In some examples, in block 806, the wireless communication device can transmit a data frame to the second wireless communication device according to transmission parameters selected according to the indicated set of transmission parameters. For example, in the operating environment 600 of FIG. 6, the wireless communication device 502 can select the transmission parameters 627 according to the transmission parameters 620 indicated by the channel feedback information 624 included in the block acknowledgment frame 622, and can transmit the data frame 628 to the wireless communication device 504 according to the transmission parameters 627.

FIG. 9 shows a block diagram of a first example wireless communication device 900 that supports fast transmission parameter adaptation based on eSINR. In some implementations, the wireless communication device 900 can be configured to perform the process 700 described above with reference to FIG. 7, the process 800 described above with reference to FIG. 8, or both. The wireless communication device 900 may be an example implementation of wireless communication device 502 or wireless communication device 504 of FIGS. 5 and 6. In some implementations, the wireless communication device 900 can be a chip, SoC, chipset, package or device that may include: one or more modems (such as, a Wi-Fi (IEEE 802.11) modem or a cellular modem such as 3GPP 4G LTE or 5G compliant modem), one or more processors, processing blocks or processing elements (collectively “the processor”); one or more radios (collectively “the radio”); and one or more memories or memory blocks (collectively “the memory”). In some implementations, the wireless communication device 900 can be a device for use in a wireless STA, such as one of the wireless STAs 104 described above with reference to FIG. 1. In other implementations, the wireless communication device 900 can be a wireless STA that includes such a chip, SoC, chipset package or device as well as at least one antenna.

In some implementations, the wireless communication device 900 can be capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. The wireless communication device 900 may include components for bi-directional communications including components for transmitting and receiving communications, such as a communications manager 920, an input/output (I/O) controller 910, a transceiver 915, an antenna 925, a memory 930, code 935 and a processor 940. These components may be in electronic communication or otherwise coupled (such as operatively, communicatively, functionally, electronically, electrically) via one or more buses (such as a bus 945). In some implementations, the wireless communication device 900 can further include a user interface (UI) (such as a touchscreen or keypad) and a display, which may be integrated with the UI to form a touchscreen display. In some implementations, the wireless communication device 900 may further include one or more sensors such as, for example, one or more inertial sensors, accelerometers, temperature sensors, pressure sensors or altitude sensors.

The I/O controller 910 may manage input and output signals for the wireless communication device 900. The I/O controller 910 also may manage peripherals not integrated into the wireless communication device 900. In some implementations, the I/O controller 910 may represent a physical connection or port to an external peripheral. In some implementations, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some implementations, the I/O controller 910 may be implemented as part of a processor or processing system, such as the processor 940. In some implementations, a user may interact with the wireless communication device 900 via the I/O controller 910 or via hardware components controlled by the I/O controller 910.

In some implementations, the wireless communication device 900 may include a single antenna 925. However, in some other implementations, the wireless communication device 900 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 also may include a modem to modulate the packets, to provide the modulated packets to one or more antennas 925 for transmission, and to demodulate packets received from the one or more antennas 925.

In some implementations, the transceiver 915 may include one or more interfaces, such as one or more interfaces coupled with the one or more antennas 925 that are configured to support various receiving or obtaining operations, or one or more interfaces coupled with the one or more antennas 925 that are configured to support various transmitting or outputting operations, or a combination thereof. In some implementations, the transceiver 915 may include or be configured for coupling with one or more processors or memory components that are operable to perform or support operations associated with received or obtained information or signals, or to generate information or other signals for transmission or other outputting, or any combination thereof. In some implementations, the transceiver 915, or the transceiver 915 and the one or more antennas 925, or the transceiver 915 and the one or more antennas 925 and one or more processors or memory components (for example, the processor 940, or the memory 930, or both), may be included in a chip or chip assembly that is installed in the wireless communication device 900.

The memory 930 may include random access memory (RAM) and read-only memory (ROM). The memory 930 may store computer-readable, computer-executable code 935 including instructions that, when executed by the processor 940, cause the wireless communication device 900 to perform various functions described herein. The code 935 may be stored in a non-transitory computer-readable medium such as system memory or another type of memory. In some implementations, the code 935 may not be directly executable by the processor 940 but may cause a computer (for example, when compiled and executed) to perform functions described herein. In some implementations, the memory 930 may contain, among other things, a basic I/O system (BIOS) which may control basic hardware or software operation such as the interaction with peripheral components or devices.

The processor 940 may be any one or more suitable processors capable of executing scripts or instructions of one or more software programs stored in the wireless communication device 900 (such as within the memory 930). In some implementations, the processor 940 may be a component of a processing system. A processing system may generally refer to a system or series of machines or components that receives inputs and processes the inputs to produce a set of outputs (which may be passed to other systems or components of, for example, the wireless communication device 900). For example, a processing system of the wireless communication device 900 may refer to a system including the various other components or subcomponents of the wireless communication device 900, such as the processor 940, or the transceiver 915, or the communications manager 920, or other components or combinations of components of the wireless communication device 900.

The processing system of the wireless communication device 900 may interface with other components of the wireless communication device 900, and may process information received from other components (such as inputs or signals) or output information to other components. For example, a chip or modem of the wireless communication device 900 may include a processing system, a first interface to output information and a second interface to obtain information. In some implementations, the first interface may refer to an interface between the processing system of the chip or modem and a transmitter, such that the wireless communication device 900 may transmit information output from the chip or modem. In some implementations, the second interface may refer to an interface between the processing system of the chip or modem and a receiver, such that the wireless communication device 900 may obtain information or signal inputs, and the information may be passed to the processing system. A person having ordinary skill in the art will readily recognize that the first interface also may obtain information or signal inputs, and the second interface also may output information or signal outputs.

The communications manager 920 may support wireless communication by wireless communication device 900 in accordance with examples as disclosed herein. In some implementations, the communications manager 920 may be configured to perform various operations (for example, receiving, monitoring, transmitting) using or otherwise in cooperation with the transceiver 915, the one or more antennas 925, or any combination thereof. Although the communications manager 920 is illustrated as a separate component, in some implementations, one or more functions described with reference to the communications manager 920 may be supported by or performed by the processor 940, the memory 930, the code 935, or any combination thereof. For example, the code 935 may include instructions executable by the processor 940 to cause the wireless communication device 900 to perform various aspects of fast transmission parameter adaptation based on eSINR as described herein, or the processor 940 and the memory 930 may be otherwise configured to perform or support such operations.

In some examples, the communications manager 920 may be configured as or otherwise support a means for receiving a packet from second wireless communication device. In some examples, the packet can include a probe frame. In some other examples, the packet can include a QoS null frame.

In some examples, the communications manager 920 may be configured as or otherwise support a means for transmitting a block acknowledgment frame to the second wireless communication device that includes channel feedback information indicating a set of transmission parameters, including a MCS, associated with an eSINR associated with the receipt of the packet, where the eSINR corresponds to an average MIR associated with the receipt of the packet according to an MIR-to-SINR mapping function.

In some examples, the set of transmission parameters can further include a number of spatial streams (N_{SS}). In some such examples, the channel feedback information can include an index value that indicates a combination of the MCS and the N_{SS}. In some examples, the channel feedback information can indicate an SINR surplus associated with a difference between the eSINR and an SINR threshold that corresponds to a combination of the MCS and the N_{SS}. In some other examples, the channel feedback information can indicate an SINR shortfall associated with a difference between the eSINR and an SINR threshold that corresponds to a second combination of a MCS and a N_{SS} associated with a higher data rate capacity than the first combination.

In some examples, the communications manager 920 may be configured as or otherwise support a means for transmitting a packet to a second wireless communication device. In some examples, the packet can include a probe frame. In some other examples, the packet can include a QoS null frame.

In some examples, the communications manager 920 may be configured as or otherwise support a means for receiving a block acknowledgement frame from the second wireless communication device that includes channel feedback information indicating a set of transmission parameters including an MCS. In some examples, the set of transmission parameters can further include a number of spatial streams (N_{SS}). In some such examples, the channel feedback information can include an index value that indicates a combination of the MCS and the N_{SS}. In some examples, the channel feedback information can indicate an SINR surplus associated with a difference between an eSINR associated with a receipt of the packet by the second wireless communication device and an SINR threshold that corresponds to a combination of the MCS and the N_{SS}. In some other examples, the channel feedback information can indicate an SINR shortfall associated with a difference between an eSINR associated with a receipt of the packet by the second wireless communication device and an SINR threshold that corresponds to a second combination of a MCS and a N_{SS} associated with a higher data rate capacity than the combination indicated by the channel feedback information.

In some examples, the communications manager 920 may be configured as or otherwise support a means for transmitting a data frame to the second wireless communication device according to transmission parameters selected according to the indicated set of transmission parameters.

In some examples, the communications manager 920 may be configured as or otherwise support a means for providing transmit power backoff information to the second wireless communication device, the transmit power backoff information indicating a transmit power backoff to be applied by the wireless communication device for the MCS. In some examples, the transmit power backoff information can indicate respective transmit power backoffs to be applied by the wireless communication device for each of a plurality of MCSs including the MCS. In some examples, the transmit power backoff information can be provided to the second wireless communication device during an association of the wireless communication device with the second wireless communication device.

FIG. 10 shows a block diagram of a second example wireless communication device 1000 that supports fast transmission parameter adaptation based on eSINR. In some implementations, the wireless communication device 1000 can be configured to perform the process 700 described above with reference to FIG. 7, the process 800 described above with reference to FIG. 8, or both. The wireless communication device 1000 may be an example implementation of wireless communication device 502 or wireless communication device 504 of FIGS. 5 and 6. In some implementations, the wireless communication device 1000 can be a chip, SoC, chipset, package or device that may include: one or more modems (such as, a Wi-Fi (IEEE 802.11) modem or a cellular modem such as 3GPP 4G LTE or 5G compliant modem), one or more processors, processing blocks or processing elements (collectively “the processor”); one or more radios (collectively “the radio”); and one or more memories or memory blocks (collectively “the memory”). In some implementations, the wireless communication device 1000 can be a device for use in a wireless AP, such as the wireless AP 102 described above with reference to FIG. 1. In other implementations, the wireless communication device 1000 can be a wireless AP that includes such a chip, SoC, chipset package or device as well as at least one antenna.

In some implementations, the wireless communication device 1000 can be capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. The wireless communication device 1000 may include components for bi-directional communications including components for transmitting and receiving communications, such as a communications manager 1020, an input/output (I/O) controller 1010, a transceiver 1015, an antenna 1025, a memory 1030, code 1035 and a processor 1040. These components may be in electronic communication or otherwise coupled (such as operatively, communicatively, functionally, electronically, electrically) via one or more buses (such as a bus 1045).

The I/O controller 1010 may manage input and output signals for the wireless communication device 1000. The I/O controller 1010 also may manage peripherals not integrated into the wireless communication device 1000. In some implementations, the I/O controller 1010 may represent a physical connection or port to an external peripheral. In some implementations, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some implementations, the I/O controller 1010 may be implemented as part of a processor or processing system, such as the processor 1040. In some implementations, a user may interact with the wireless communication device 1000 via the I/O controller 1010 or via hardware components controlled by the I/O controller 1010.

In some implementations, the wireless communication device 1000 may include a single antenna 1025. However, in some other implementations, the wireless communication device 1000 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 also may include a modem to modulate the packets, to provide the modulated packets to one or more antennas 1025 for transmission, and to demodulate packets received from the one or more antennas 1025.

In some implementations, the transceiver 1015 may include one or more interfaces, such as one or more interfaces coupled with the one or more antennas 1025 that are configured to support various receiving or obtaining operations, or one or more interfaces coupled with the one or more antennas 1025 that are configured to support various transmitting or outputting operations, or a combination thereof. In some implementations, the transceiver 1015 may include or be configured for coupling with one or more processors or memory components that are operable to perform or support operations associated with received or obtained information or signals, or to generate information or other signals for transmission or other outputting, or any combination thereof. In some implementations, the transceiver 1015, or the transceiver 1015 and the one or more antennas 1025, or the transceiver 1015 and the one or more antennas 1025 and one or more processors or memory components (for example, the processor 1040, or the memory 1030, or both), may be included in a chip or chip assembly that is installed in the wireless communication device 1000.

The memory 1030 may include random access memory (RAM) and read-only memory (ROM). The memory 1030 may store computer-readable, computer-executable code 1035 including instructions that, when executed by the processor 1040, cause the wireless communication device 1000 to perform various functions described herein. The code 1035 may be stored in a non-transitory computer-readable medium such as system memory or another type of memory. In some implementations, the code 1035 may not be directly executable by the processor 1040 but may cause a computer (for example, when compiled and executed) to perform functions described herein. In some implementations, the memory 1030 may contain, among other things, a basic I/O system (BIOS) which may control basic hardware or software operation such as the interaction with peripheral components or devices.

The processor 1040 may be any one or more suitable processors capable of executing scripts or instructions of one or more software programs stored in the wireless communication device 1000 (such as within the memory 1030). In some implementations, the processor 1040 may be a component of a processing system. A processing system may generally refer to a system or series of machines or components that receives inputs and processes the inputs to produce a set of outputs (which may be passed to other systems or components of, for example, the wireless communication device 1000). For example, a processing system of the wireless communication device 1000 may refer to a system including the various other components or subcomponents of the wireless communication device 1000, such as the processor 1040, or the transceiver 1015, or the communications manager 1020, or other components or combinations of components of the wireless communication device 1000.

The processing system of the wireless communication device 1000 may interface with other components of the wireless communication device 1000, and may process information received from other components (such as inputs or signals) or output information to other components. For example, a chip or modem of the wireless communication device 1000 may include a processing system, a first interface to output information and a second interface to obtain information. In some implementations, the first interface may refer to an interface between the processing system of the chip or modem and a transmitter, such that the wireless communication device 1000 may transmit information output from the chip or modem. In some implementations, the second interface may refer to an interface between the processing system of the chip or modem and a receiver, such that the wireless communication device 1000 may obtain information or signal inputs, and the information may be passed to the processing system. A person having ordinary skill in the art will readily recognize that the first interface also may obtain information or signal inputs, and the second interface also may output information or signal outputs.

The communications manager 1020 may support wireless communication by wireless communication device 1000 in accordance with examples as disclosed herein. In some implementations, the communications manager 1020 may be configured to perform various operations (for example, receiving, monitoring, transmitting) using or otherwise in cooperation with the transceiver 1015, the one or more antennas 1025, or any combination thereof. Although the communications manager 1020 is illustrated as a separate component, in some implementations, one or more functions described with reference to the communications manager 1020 may be supported by or performed by the processor 1040, the memory 1030, the code 1035, or any combination thereof. For example, the code 1035 may include instructions executable by the processor 1040 to cause the wireless communication device 1000 to perform various aspects of fast transmission parameter adaptation based on eSINR as described herein, or the processor 1040 and the memory 1030 may be otherwise configured to perform or support such operations.

In some examples, the communications manager 1020 may be configured as or otherwise support a means for receiving a packet from second wireless communication device. In some examples, the packet can include a probe frame. In some other examples, the packet can include a QoS null frame.

In some examples, the communications manager 1020 may be configured as or otherwise support a means for transmitting a block acknowledgment frame to the second wireless communication device that includes channel feedback information indicating a set of transmission parameters, including a MCS, associated with an eSINR associated with the receipt of the packet, where the eSINR corresponds to an average MIR associated with the receipt of the packet according to an MIR-to-SINR mapping function.

In some examples, the set of transmission parameters can further include a number of spatial streams (N_{SS}). In some such examples, the channel feedback information can include an index value that indicates a combination of the MCS and the N_{SS}. In some examples, the channel feedback information can indicate an SINR surplus associated with a difference between the eSINR and an SINR threshold that corresponds to a combination of the MCS and the N_{SS}. In some other examples, the channel feedback information can indicate an SINR shortfall associated with a difference between the eSINR and an SINR threshold that corresponds to a second combination of a MCS and a N_{SS} associated with a higher data rate capacity than the first combination.

In some examples, the communications manager 1020 may be configured as or otherwise support a means for transmitting a packet to a second wireless communication device. In some examples, the packet can include a probe frame. In some other examples, the packet can include a QoS null frame.

In some examples, the communications manager 1020 may be configured as or otherwise support a means for receiving a block acknowledgement frame from the second wireless communication device that includes channel feedback information indicating a set of transmission parameters including an MCS. In some examples, the set of transmission parameters can further include a number of spatial streams (N_{SS}). In some such examples, the channel feedback information can include an index value that indicates a combination of the MCS and the N_{SS}. In some examples, the channel feedback information can indicate an SINR surplus associated with a difference between an eSINR associated with a receipt of the packet by the second wireless communication device and an SINR threshold that corresponds to a combination of the MCS and the N_{SS}. In some other examples, the channel feedback information can indicate an SINR shortfall associated with a difference between an eSINR associated with a receipt of the packet by the second wireless communication device and an SINR threshold that corresponds to a second combination of a MCS and a N_{SS} associated with a higher data rate capacity than the combination indicated by the channel feedback information.

In some examples, the communications manager 1020 may be configured as or otherwise support a means for transmitting a data frame to the second wireless communication device according to transmission parameters selected according to the indicated set of transmission parameters.

In some examples, the communications manager 1020 may be configured as or otherwise support a means for providing transmit power backoff information to the second wireless communication device, the transmit power backoff information indicating a transmit power backoff to be applied by the wireless communication device for the MCS. In some examples, the transmit power backoff information can indicate respective transmit power backoffs to be applied by the wireless communication device for each of a plurality of MCSs including the MCS. In some examples, the transmit power backoff information can be provided to the second wireless communication device during an association of the wireless communication device with the second wireless communication device.

Implementation examples are described in the following numbered clauses:

Clause 1. A wireless communication device, including at least one memory, and at least one processor communicatively coupled with the at least one memory, the at least one processor operable to cause the wireless communication device to receive a packet from a second wireless communication device, and transmit a block acknowledgment frame to the second wireless communication device that includes channel feedback information indicating a set of transmission parameters, including a modulation and coding scheme (MCS), associated with an effective signal-to-interference-plus-noise ratio (SINR) associated with the receipt of the packet, where the effective SINR (eSINR) corresponds to an average mutual information rate (MIR) associated with the receipt of the packet according to an MIR-to-SINR mapping function.

Clause 2. The wireless communication device of clause 1, where the wireless communication device is a wireless station (STA) and the second wireless communication device is a wireless access point (AP).

Clause 3. The wireless communication device of clause 1, where the wireless communication device is a wireless access point (AP) and the second wireless communication device is a wireless station (STA).

Clause 4. The wireless communication device of any of clauses 1 to 3, where the packet includes a probe frame.

Clause 5. The wireless communication device of any of clauses 1 to 3, where the packet includes a quality of service (QoS) null frame.

Clause 6. The wireless communication device of any of clauses 1 to 5, where the set of transmission parameters further includes a number of spatial streams (NSS).

Clause 7. The wireless communication device of clause 6, where the channel feedback information includes an index value that indicates a combination of the MCS and the N_{SS}.

Clause 8. The wireless communication device of any of clauses 6 to 7, where the channel feedback information indicates an SINR surplus associated with a difference between the eSINR and an SINR threshold that corresponds to a combination of the MCS and the NSS.

Clause 9. The wireless communication device of any of clauses 6 to 7, where the channel feedback information indicates a first combination of the MCS and the NSS, and indicates an SINR shortfall associated with a difference between the eSINR and an SINR threshold that corresponds to a second combination of a MCS and a NSS associated with a higher data rate capacity than the first combination.

Clause 10. The wireless communication device of any of clauses 1 to 9, where the at least one processor is operable to cause the wireless communication device to estimate a plurality of SINRs for a plurality of tones for a plurality of spatial streams, on a per-tone per-spatial-stream basis, associated with receipt of the packet, and obtain the eSINR using a lookup table (LUT) according to the estimated plurality of SINRs.

Clause 11. The wireless communication device of any of clauses 1 to 10, where the at least one processor is operable to cause the wireless communication device to select the set of transmission parameters according to transmission parameter mapping information that indicates a mapping of the eSINR to the set of transmission parameters.

Clause 12. The wireless communication device of any of clauses 1 to 11, where the at least one processor is operable to cause the wireless communication device to select the set of transmission parameters according to the eSINR and transmit power backoff information obtained from the second wireless communication device, the transmit power backoff information indicating a transmit power backoff associated with the MCS.

Clause 13. The wireless communication device of clause 12, where the transmit power backoff information indicates respective associated transmit power backoffs for each of a plurality of MCSs including the MCS.

Clause 14. The wireless communication device of any of clauses 12 to 13, where the at least one processor is operable to cause the wireless communication device to obtain the transmit power backoff information from the second wireless communication device during an association of the wireless communication device with the second wireless communication device.

Clause 15. A method for wireless communication by a wireless communication device, including receiving a packet from a second wireless communication device, and transmitting a block acknowledgment frame to the second wireless communication device that includes channel feedback information indicating a set of transmission parameters, including a modulation and coding scheme (MCS), associated with an effective signal-to-interference-plus-noise ratio (SINR) associated with the receipt of the packet, where the effective SINR (eSINR) corresponds to an average mutual information rate (MIR) associated with the receipt of the packet according to an MIR-to-SINR mapping function.

Clause 16. The method of clause 15, where the wireless communication device is a wireless station (STA) and the second wireless communication device is a wireless access point (AP).

Clause 17. The method of clause 15, where the wireless communication device is a wireless access point (AP) and the second wireless communication device is a wireless station (STA).

Clause 18. The method of any of clauses 15 to 17, where the packet includes a probe frame.

Clause 19. The method of any of clauses 15 to 17, where the packet includes a quality of service (QoS) null frame.

Clause 20. The method of any of clauses 15 to 19, where the set of transmission parameters further includes a number of spatial streams (NSS).

Clause 21. The method of clause 20, where the channel feedback information includes an index value that indicates a combination of the MCS and the NSS.

Clause 22. The method of any of clauses 20 to 21, where the channel feedback information indicates an SINR surplus associated with a difference between the eSINR and an SINR threshold that corresponds to a combination of the MCS and the NSS.

Clause 23. The method of any of clauses 20 to 21, where the channel feedback information indicates a first combination of the MCS and the NSS, and indicates an SINR shortfall associated with a difference between the eSINR and an SINR threshold that corresponds to a second combination of a MCS and a NSS associated with a higher data rate capacity than the first combination.

Clause 24. The method of any of clauses 15 to 23, further including estimating a plurality of SINRs for a plurality of tones for a plurality of spatial streams, on a per-tone per-spatial-stream basis, associated with receipt of the packet, and obtaining the eSINR using a lookup table (LUT) according to the estimated plurality of SINRs.

Clause 25. The method of any of clauses 15 to 24, further including selecting the set of transmission parameters according to transmission parameter mapping information that indicates a mapping of the eSINR to the set of transmission parameters.

Clause 26. The method of any of clauses 15 to 25, further including selecting the set of transmission parameters according to the eSINR and transmit power backoff information obtained from the second wireless communication device, the transmit power backoff information indicating a transmit power backoff associated with the MCS.

Clause 27. The method of clause 26, where the transmit power backoff information indicates respective associated transmit power backoffs for each of a plurality of MCSs including the MCS.

Clause 28. The method of any of clauses 26 to 27, further including obtaining the transmit power backoff information from the second wireless communication device during an association of the wireless communication device with the second wireless communication device.

Clause 29. An apparatus for wireless communication by a wireless communication device, including means for receiving a packet from a second wireless communication device, and means for transmitting a block acknowledgment frame to the second wireless communication device that includes channel feedback information indicating a set of transmission parameters, including a modulation and coding scheme (MCS), associated with an effective signal-to-interference-plus-noise ratio (SINR) associated with the receipt of the packet, where the effective SINR (eSINR) corresponds to an average mutual information rate (MIR) associated with the receipt of the packet according to an MIR-to-SINR mapping function.

Clause 30. The apparatus of clause 29, where the wireless communication device is a wireless station (STA) and the second wireless communication device is a wireless access point (AP).

Clause 31. The apparatus of clause 29, where the wireless communication device is a wireless access point (AP) and the second wireless communication device is a wireless station (STA).

Clause 32. The apparatus of any of clauses 29 to 31, where the packet includes a probe frame.

Clause 33. The apparatus of any of clauses 29 to 31, where the packet includes a quality of service (QoS) null frame.

Clause 34. The apparatus of any of clauses 29 to 33, where the set of transmission parameters further includes a number of spatial streams (NSS).

Clause 35. The apparatus of clause 34, where the channel feedback information includes an index value that indicates a combination of the MCS and the NSS.

Clause 36. The apparatus of any of clauses 34 to 35, where the channel feedback information indicates an SINR surplus associated with a difference between the eSINR and an SINR threshold that corresponds to a combination of the MCS and the NSS.

Clause 37. The apparatus of any of clauses 34 to 35, where the channel feedback information indicates a first combination of the MCS and the NSS, and indicates an SINR shortfall associated with a difference between the eSINR and an SINR threshold that corresponds to a second combination of a MCS and a NSS associated with a higher data rate capacity than the first combination.

Clause 38. The apparatus of any of clauses 29 to 37, further including means for estimating a plurality of SINRs for a plurality of tones for a plurality of spatial streams, on a per-tone per-spatial-stream basis, associated with receipt of the packet, and means for obtaining the eSINR using a lookup table (LUT) according to the estimated plurality of SINRs.

Clause 39. The apparatus of any of clauses 29 to 38, further including means for selecting the set of transmission parameters according to transmission parameter mapping information that indicates a mapping of the eSINR to the set of transmission parameters.

Clause 40. The apparatus of any of clauses 29 to 39, further including means for selecting the set of transmission parameters according to the eSINR and transmit power backoff information obtained from the second wireless communication device, the transmit power backoff information indicating a transmit power backoff associated with the MCS.

Clause 41. The apparatus of clause 40, where the transmit power backoff information indicates respective associated transmit power backoffs for each of a plurality of MCSs including the MCS.

Clause 42. The apparatus of any of clauses 40 to 41, further including means for obtaining the transmit power backoff information from the second wireless communication device during an association of the wireless communication device with the second wireless communication device.

Clause 43. One or more non-transitory computer-readable media having instructions for wireless communication by a wireless communication device stored thereon which, when executed by a processor of the wireless communication device, cause the wireless communication device to receive a packet from a second wireless communication device, and transmit a block acknowledgment frame to the second wireless communication device that includes channel feedback information indicating a set of transmission parameters, including a modulation and coding scheme (MCS), associated with an effective signal-to-interference-plus-noise ratio (SINR) associated with the receipt of the packet, where the effective SINR (eSINR) corresponds to an average mutual information rate (MIR) associated with the receipt of the packet according to an MIR-to-SINR mapping function.

Clause 44. The one or more non-transitory computer-readable media of clause 43, where the wireless communication device is a wireless station (STA) and the second wireless communication device is a wireless access point (AP).

Clause 45. The one or more non-transitory computer-readable media of clause 43, where the wireless communication device is a wireless access point (AP) and the second wireless communication device is a wireless station (STA).

Clause 46. The one or more non-transitory computer-readable media of any of clauses 43 to 45, where the packet includes a probe frame.

Clause 47. The one or more non-transitory computer-readable media of any of clauses 43 to 45, where the packet includes a quality of service (QoS) null frame.

Clause 48. The one or more non-transitory computer-readable media of any of clauses 43 to 47, where the set of transmission parameters further includes a number of spatial streams (NSS).

Clause 49. The one or more non-transitory computer-readable media of clause 48, where the channel feedback information includes an index value that indicates a combination of the MCS and the NSS.

Clause 50. The one or more non-transitory computer-readable media of any of clauses 48 to 49, where the channel feedback information indicates an SINR surplus associated with a difference between the eSINR and an SINR threshold that corresponds to a combination of the MCS and the NSS.

Clause 51. The one or more non-transitory computer-readable media of any of clauses 48 to 49, where the channel feedback information indicates a first combination of the MCS and the NSS, and indicates an SINR shortfall associated with a difference between the eSINR and an SINR threshold that corresponds to a second combination of a MCS and a NSS associated with a higher data rate capacity than the first combination.

Clause 52. The one or more non-transitory computer-readable media of any of clauses 43 to 51, further having instructions for wireless communication by the wireless communication device stored thereon which, when executed by the processor of the wireless communication device, cause the wireless communication device to estimate a plurality of SINRs for a plurality of tones for a plurality of spatial streams, on a per-tone per-spatial-stream basis, associated with receipt of the packet, and obtain the eSINR using a lookup table (LUT) according to the estimated plurality of SINRs.

Clause 53. The one or more non-transitory computer-readable media of any of clauses 43 to 52, further having instructions for wireless communication by the wireless communication device stored thereon which, when executed by the processor of the wireless communication device, cause the wireless communication device to select the set of transmission parameters according to transmission parameter mapping information that indicates a mapping of the eSINR to the set of transmission parameters.

Clause 54. The one or more non-transitory computer-readable media of any of clauses 43 to 53, further having instructions for wireless communication by the wireless communication device stored thereon which, when executed by the processor of the wireless communication device, cause the wireless communication device to select the set of transmission parameters according to the eSINR and transmit power backoff information obtained from the second wireless communication device, the transmit power backoff information indicating a transmit power backoff associated with the MCS.

Clause 55. The one or more non-transitory computer-readable media of clause 54, where the transmit power backoff information indicates respective associated transmit power backoffs for each of a plurality of MCSs including the MCS.

Clause 56. The one or more non-transitory computer-readable media of any of clauses 54 to 55, further having instructions for wireless communication by the wireless communication device stored thereon which, when executed by the processor of the wireless communication device, cause the wireless communication device to obtain the transmit power backoff information from the second wireless communication device during an association of the wireless communication device with the second wireless communication device.

Clause 57. A wireless communication device, including at least one memory, and at least one processor communicatively coupled with the at least one memory, the at least one processor operable to cause the wireless communication device to transmit a packet to a second wireless communication device, receive a block acknowledgement frame from the second wireless communication device that includes channel feedback information indicating a set of transmission parameters including a modulation and coding scheme (MCS), and transmit a data frame to the second wireless communication device according to transmission parameters selected according to the indicated set of transmission parameters.

Clause 58. The wireless communication device of clause 57, where the wireless communication device is a wireless station (STA) and the second wireless communication device is a wireless access point (AP).

Clause 59. The wireless communication device of clause 57, where the wireless communication device is a wireless access point (AP) and the second wireless communication device is a wireless station (STA).

Clause 60. The wireless communication device of any of clauses 57 to 59, where the packet includes a probe frame.

Clause 61. The wireless communication device of any of clauses 57 to 59, where the packet includes a quality of service (QoS) null frame.

Clause 62. The wireless communication device of any of clauses 57 to 61, where the set of transmission parameters further includes a number of spatial streams (NSS).

Clause 63. The wireless communication device of clause 62, where the channel feedback information includes an index value that indicates a combination of the MCS and the NSS.

Clause 64. The wireless communication device of any of clauses 62 to 63, where the channel feedback information indicates an SINR surplus associated with a difference between an eSINR associated with a receipt of the packet by the second wireless communication device and an SINR threshold that corresponds to a combination of the MCS and the NSS.

Clause 65. The wireless communication device of any of clauses 62 to 63, where the channel feedback information indicates a first combination of the MCS and the NSS, and indicates an SINR shortfall associated with a difference between an eSINR associated with a receipt of the packet by the second wireless communication device and an SINR threshold that corresponds to a second combination of a MCS and a NSS associated with a higher data rate capacity than the first combination.

Clause 66. The wireless communication device of any of clauses 57 to 65, where the at least one processor is operable to cause the wireless communication device to provide transmit power backoff information to the second wireless communication device, the transmit power backoff information indicating a transmit power backoff to be applied by the wireless communication device for the MCS.

Clause 67. The wireless communication device of clause 66, where the transmit power backoff information indicates respective transmit power backoffs to be applied by the wireless communication device for each of a plurality of MCSs including the MCS.

Clause 68. The wireless communication device of any of clauses 66 to 67, where the at least one processor is operable to cause the wireless communication device to provide the transmit power backoff information to the second wireless communication device during an association of the wireless communication device with the second wireless communication device.

Clause 69. A method for wireless communication by a wireless communication device, including transmitting a packet to a second wireless communication device, receiving a block acknowledgement frame from the second wireless communication device that includes channel feedback information indicating a set of transmission parameters including a modulation and coding scheme (MCS), and transmitting a data frame to the second wireless communication device according to transmission parameters selected according to the indicated set of transmission parameters.

Clause 70. The method of clause 69, where the wireless communication device is a wireless station (STA) and the second wireless communication device is a wireless access point (AP).

Clause 71. The method of clause 69, where the wireless communication device is a wireless access point (AP) and the second wireless communication device is a wireless station (STA).

Clause 72. The method of any of clauses 69 to 71, where the packet includes a probe frame.

Clause 73. The method of any of clauses 69 to 71, where the packet includes a quality of service (QoS) null frame.

Clause 74. The method of any of clauses 69 to 73, where the set of transmission parameters further includes a number of spatial streams (NSS).

Clause 75. The method of clause 74, where the channel feedback information includes an index value that indicates a combination of the MCS and the NSS.

Clause 76. The method of any of clauses 74 to 75, where the channel feedback information indicates an SINR surplus associated with a difference between an eSINR associated with a receipt of the packet by the second wireless communication device and an SINR threshold that corresponds to a combination of the MCS and the NSS.

Clause 77. The method of any of clauses 74 to 75, where the channel feedback information indicates a first combination of the MCS and the NSS, and indicates an SINR shortfall associated with a difference between an eSINR associated with a receipt of the packet by the second wireless communication device and an SINR threshold that corresponds to a second combination of a MCS and a NSS associated with a higher data rate capacity than the first combination.

Clause 78. The method of any of clauses 69 to 77, further including providing transmit power backoff information to the second wireless communication device, the transmit power backoff information indicating a transmit power backoff to be applied by the wireless communication device for the MCS.

Clause 79. The method of clause 78, where the transmit power backoff information indicates respective transmit power backoffs to be applied by the wireless communication device for each of a plurality of MCSs including the MCS.

Clause 80. The method of any of clauses 78 to 79, further including providing the transmit power backoff information to the second wireless communication device during an association of the wireless communication device with the second wireless communication device.

Clause 81. An apparatus for wireless communication by a wireless communication device, including means for transmitting a packet to a second wireless communication device, means for receiving a block acknowledgement frame from the second wireless communication device that includes channel feedback information indicating a set of transmission parameters including a modulation and coding scheme (MCS), and means for transmitting a data frame to the second wireless communication device according to transmission parameters selected according to the indicated set of transmission parameters.

Clause 82. The apparatus of clause 81, where the wireless communication device is a wireless station (STA) and the second wireless communication device is a wireless access point (AP).

Clause 83. The apparatus of clause 81, where the wireless communication device is a wireless access point (AP) and the second wireless communication device is a wireless station (STA).

Clause 84. The apparatus of any of clauses 81 to 83, where the packet includes a probe frame.

Clause 85. The apparatus of any of clauses 81 to 83, where the packet includes a quality of service (QoS) null frame.

Clause 86. The apparatus of any of clauses 81 to 85, where the set of transmission parameters further includes a number of spatial streams (NSS).

Clause 87. The apparatus of clause 86, where the channel feedback information includes an index value that indicates a combination of the MCS and the NSS.

Clause 88. The apparatus of any of clauses 86 to 87, where the channel feedback information indicates an SINR surplus associated with a difference between an eSINR associated with a receipt of the packet by the second wireless communication device and an SINR threshold that corresponds to a combination of the MCS and the NSS.

Clause 89. The apparatus of any of clauses 86 to 87, where the channel feedback information indicates a first combination of the MCS and the NSS, and indicates an SINR shortfall associated with a difference between an eSINR associated with a receipt of the packet by the second wireless communication device and an SINR threshold that corresponds to a second combination of a MCS and a NSS associated with a higher data rate capacity than the first combination.

Clause 90. The apparatus of any of clauses 81 to 89, further including means for providing transmit power backoff information to the second wireless communication device, the transmit power backoff information indicating a transmit power backoff to be applied by the wireless communication device for the MCS.

Clause 91. The apparatus of clause 90, where the transmit power backoff information indicates respective transmit power backoffs to be applied by the wireless communication device for each of a plurality of MCSs including the MCS.

Clause 92. The apparatus of any of clauses 90 to 91, further including means for providing the transmit power backoff information to the second wireless communication device during an association of the wireless communication device with the second wireless communication device.

Clause 93. One or more non-transitory computer-readable media having instructions for wireless communication by a wireless communication device stored thereon which, when executed by a processor of the wireless communication device, cause the wireless communication device to transmit a packet to a second wireless communication device, receive a block acknowledgement frame from the second wireless communication device that includes channel feedback information indicating a set of transmission parameters including a modulation and coding scheme (MCS), and transmit a data frame to the second wireless communication device according to transmission parameters selected according to the indicated set of transmission parameters.

Clause 94. The one or more non-transitory computer-readable media of clause 93, where the wireless communication device is a wireless station (STA) and the second wireless communication device is a wireless access point (AP).

Clause 95. The one or more non-transitory computer-readable media of clause 93, where the wireless communication device is a wireless access point (AP) and the second wireless communication device is a wireless station (STA).

Clause 96. The one or more non-transitory computer-readable media of any of clauses 93 to 95, where the packet includes a probe frame.

Clause 97. The one or more non-transitory computer-readable media of any of clauses 93 to 95, where the packet includes a quality of service (QoS) null frame.

Clause 98. The one or more non-transitory computer-readable media of any of clauses 93 to 97, where the set of transmission parameters further includes a number of spatial streams (NSS).

Clause 99. The one or more non-transitory computer-readable media of clause 98, where the channel feedback information includes an index value that indicates a combination of the MCS and the NSS.

Clause 100. The one or more non-transitory computer-readable media of any of clauses 98 to 99, where the channel feedback information indicates an SINR surplus associated with a difference between an eSINR associated with a receipt of the packet by the second wireless communication device and an SINR threshold that corresponds to a combination of the MCS and the NSS.

Clause 101. The one or more non-transitory computer-readable media of any of clauses 98 to 99, where the channel feedback information indicates a first combination of the MCS and the NSS, and indicates an SINR shortfall associated with a difference between an eSINR associated with a receipt of the packet by the second wireless communication device and an SINR threshold that corresponds to a second combination of a MCS and a NSS associated with a higher data rate capacity than the first combination.

Clause 102. The one or more non-transitory computer-readable media of any of clauses 93 to 101, further having instructions for wireless communication by the wireless communication device stored thereon which, when executed by the processor of the wireless communication device, cause the wireless communication device to provide transmit power backoff information to the second wireless communication device, the transmit power backoff information indicating a transmit power backoff to be applied by the wireless communication device for the MCS.

Clause 103. The one or more non-transitory computer-readable media of clause 102, where the transmit power backoff information indicates respective transmit power backoffs to be applied by the wireless communication device for each of a plurality of MCSs including the MCS.

Clause 104. The one or more non-transitory computer-readable media of any of clauses 102 to 103, further having instructions for wireless communication by the wireless communication device stored thereon which, when executed by the processor of the wireless communication device, cause the wireless communication device to provide the transmit power backoff information to the second wireless communication device during an association of the wireless communication device with the second wireless communication device.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,”’ or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. A wireless communication device, comprising:
at least one memory; and
at least one processor communicatively coupled with the at least one memory, the at least one processor operable to cause the wireless communication device to:
receive a packet from a second wireless communication device; and
transmit a block acknowledgment frame to the second wireless communication device that includes channel feedback information indicating a set of transmission parameters, including a modulation and coding scheme (MCS), associated with an effective signal-to-interference-plus-noise ratio (SINR) associated with the receipt of the packet, wherein the effective SINR (eSINR) corresponds to an average mutual information rate (MIR) associated with the receipt of the packet according to an MIR-to-SINR mapping function.

2. The wireless communication device of claim 1, wherein:
the wireless communication device is a wireless station (STA) and the second wireless communication device is a wireless access point (AP); or
the wireless communication device is an AP and the second wireless communication device is a STA.

3. The wireless communication device of claim 1, wherein the packet includes a probe frame or a quality of service (QoS) null frame.

4. The wireless communication device of claim 1, wherein the set of transmission parameters further includes a number of spatial streams (Nss).

5. The wireless communication device of claim 4, wherein the channel feedback in information includes an index value that indicates a combination of the MCS and the Nss.

6. The wireless communication device of claim 4, wherein the channel feedback information indicates an SINR surplus associated with a difference between the eSINR and an SINR threshold that corresponds to a combination of the MCS and the Nss.

7. The wireless communication device of claim 4, wherein the channel feedback information indicates a first combination of the MCS and the Nss, and indicates an SINR shortfall associated with a difference between the eSINR and an SINR threshold that corresponds to a second combination of a MCS and a Nss associated with a higher data rate capacity than the first combination.

8. The wireless communication device of claim 1, wherein the at least one processor is operable to cause the wireless communication device to:
estimate a plurality of SINRs for a plurality of tones for a plurality of spatial streams, on a per-tone per-spatial-stream basis, associated with receipt of the packet; and obtain the eSINR using a lookup table (LUT) according to the estimated plurality of SINRs.

9. The wireless communication device of claim 1, wherein the at least one processor is operable to cause the wireless communication device to select the set of transmission parameters according to transmission parameter mapping information that indicates a mapping of the eSINR to the set of transmission parameters.

10. The wireless communication device of claim 1, wherein the at least one processor is operable to cause the wireless communication device to select the set of transmission parameters according to the eSINR and transmit power backoff information obtained from the second wireless communication device, the transmit power backoff information indicating a transmit power backoff associated with the MCS.

11. The wireless communication device of claim 10, wherein the transmit power backoff information indicates respective associated transmit power backoffs for each of a plurality of MCSs including the MCS.

12. The wireless communication device of claim 10, wherein the at least one processor is operable to cause the wireless communication device to obtain the transmit power backoff information from the second wireless communication device during an association of the wireless communication device with the second wireless communication device.

13. A method for wireless communication by a wireless communication device, comprising:
receiving a packet from a second wireless communication device; and
transmitting a block acknowledgment frame to the second wireless communication device that includes channel feedback information indicating a set of transmission parameters, including a modulation and coding scheme (MCS), associated with an effective signal-to-interference-plus-noise ratio (SINR) associated with the receipt of the packet, wherein the effective SINR (eSINR) corresponds to an average mutual information rate (MIR) associated with the receipt of the packet according to an MIR-to-SINR mapping function.

14. (canceled)

15. A wireless communication device, comprising:
at least one memory; and
at least one processor communicatively coupled with the at least one memory, the at least one processor operable to cause the wireless communication device to:
transmit a packet to a second wireless communication device; receive a block acknowledgement frame from the second wireless communication device that includes channel feedback information indicating a set of transmission parameters including a modulation and coding scheme (MCS); and
transmit a data frame to the second wireless communication device according to transmission parameters selected according to the indicated set of transmission parameters.

16. The wireless communication device of claim 15, wherein:
the wireless communication device is a wireless station (STA) and the second wireless communication device is a wireless access point (AP); or
the wireless communication device is an AP and the second wireless communication device is a STA.

17. The wireless communication device of claim 15, wherein the set of transmission parameters further includes a number of spatial streams (Nss).

18. The wireless communication device of claim 17, wherein the channel feedback information includes an index value that indicates a combination of the MCS and the Nss.

19. The wireless communication device of claim 17, wherein the channel feedback information indicates an SINR surplus associated with a difference between an eSINR associated with a receipt of the packet by the second wireless communication device and an SINR threshold that corresponds to a combination of the MCS and the Nss.

20. The wireless communication device of claim 17, wherein the channel feedback information indicates a first combination of the MCS and the Nss, and indicates an SINR shortfall associated with a difference between an eSINR associated with a receipt of the packet by the second wireless communication device and an SINR threshold that corresponds to a second combination of a MCS and a Nss associated with a higher data rate capacity than the first combination

21. The wireless communication device of claim 15, wherein the at least one processor is operable to cause the wireless communication device to provide transmit power
backoff information to the second wireless communication device, the transmit power backoff information indicating a transmit power backoff to be applied by the wireless communication device for the MCS.

22-25. (canceled)
